(19) United States
(12) Patent Application Publication
(10) Pub. No.: US 2007/0061818 A1
(43) Pub. Date: Mar. 15, 2007

(54) Detection of devices during operating system setup

(75) Inventors: Charles J. Williams, Sammamish, WA (US); Craig A. Jensen, Sammamish, WA (US); Harlan Husmann, Woodinville, WA (US); Janine A. Harrison, Redmond, WA (US); Sergey I. Bykov, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/225,704

(22) Filed: Sep. 12, 2005

(51) Int. Cl. G06F 9/44

(52) U.S. Cl. 719/327

(57) ABSTRACT

A host operating system (e.g., WinPE®) detects hardware devices connected to a computing device and stores identifiers (if any) of detected hardware devices in a datastore (e.g., the WinPE® registry). Without performing a detection process, a setup program accesses the datastore to obtain identifiers of hardware devices attached to the computing device. The setup program uses a mapping file (which maps hardware devices to drivers of a set of driver files) to determine which drivers of the set of driver files are usable by the detected hardware devices. The setup file then installs the “selected” drivers into the computing device.

### BACKGROUND

A setup program is typically used to install an operating system on a computing device. During a typical installation of an operating system, some setup programs attempt to detect all of the hardware devices connected to the computing device, which can be internal or external to the computing device. Such setup programs then install drivers (e.g. a control program that enables a computer to work with a particular hardware device) needed for these hardware devices.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to aspects of various described embodiments, a system for installing a programming module (e.g. a driver) in a computing device is provided. In one aspect, a host operating system (e.g., WinPE®) detects hardware devices connected to a computing device and stores identifiers (if any) of detected hardware devices in a datastore (e.g., the WinPE® registry). Without performing a detection process, a setup program accesses the datastore to obtain identifiers of hardware devices attached to the computing device. The setup program uses a mapping file (which maps hardware devices to drivers of a set of driver files) to determine which programming module of the set of programming modules are usable by the detected hardware devices. The setup file then installs the “selected” programming module into the computing device.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram representing an exemplary system that uses device detection during host operating system installation for driver installation, according to an embodiment.

FIG. 2 is a diagram representing an example of a mapping file for use in the system of FIG. 1, according to an embodiment.

FIG. 3 is a block diagram representing an exemplary system that uses device detection during remote host operating system installation for remote driver installation, according to an embodiment.

FIG. 4 is a flow diagram representing operational flow in installing an operating system and one or more device drivers, according to an embodiment.

### DETAILED DESCRIPTION

Various embodiments are described more fully below with reference to the accompanying drawings, which form a part hereof, and which show specific exemplary embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Exemplary Operating System/Driver Installation System

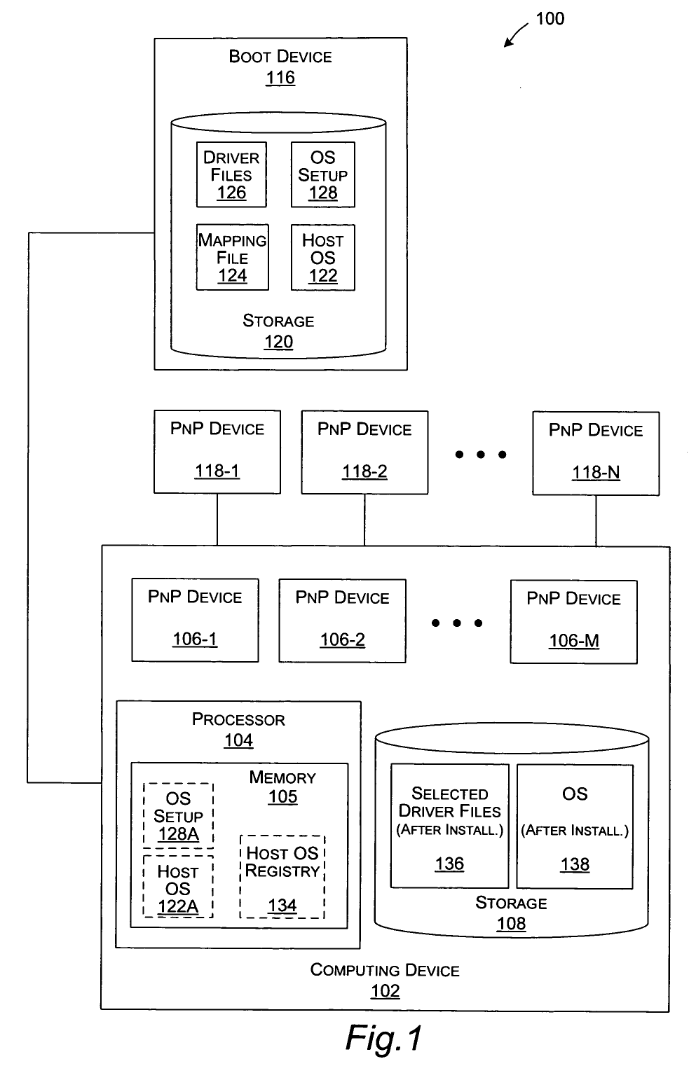

FIG. 1 illustrates an exemplary system 100 that uses device detection during host operating system initialization for driver installation, according to an embodiment. In this exemplary embodiment, system 100 includes a computing device 102 having: (a) a processor 104 (which may include, for example, a microprocessor, a memory controller, a memory 105 that can be implemented using volatile and/or non-volatile memory devices); (b) hardware devices 106-1 through 106-M; and (c) a storage device 108 (e.g., a hard drive).

In addition, system 100 includes a boot device 116 (e.g., a compact disk drive) that can be internal or external to computing device 102, and additional hardware devices 118-1 through 118-N that are external to computing device 102. In some scenarios, system 100 may have no such internal and/or external hardware devices (i.e., system 100 may have any number of such hardware devices ranging from zero to M+N). In this embodiment, hardware devices 106-1 through 106-M and 118-1 through 118-N are plug and play (PnP) devices according to specifications developed by Microsoft Corporation, Redmond, Wash. in association with processor and other hardware device manufacturers.

In accordance with one embodiment, storage device 120 has stored therein: (a) a host operating system (e.g., Windows® Pre-installation Environment (WinPE®) available from Microsoft Corporation); (b) a mapping file 124 (that stores data that associates hardware devices to the drivers needed by the hardware devices; (c) driver files 126 (typically the drivers listed in mapping file 124); (d) and an operating system setup program 128 (that performs the operating system and driver installation).

In operation during an operating system installation scenario, computing device 102 boots from boot device 116 by loading host operating system 122 from storage 120 into main memory of processor 104. The loaded host operating system is shown in FIG. 1 as host operating system 122A residing in memory 105 of processor 104.

In this embodiment, runs, one of the tasks host operating system 122A performs is detecting all of the hardware devices connected to computing device 102. In this example embodiment, host operating system 122A operates to detect PnP devices 106-1 through 106-M and PnP devices 118-1 through 118-N. Host operating system 122A stores identifiers for the detected devices in a data structure. In this embodiment, the identifiers are locally stored in a registry 134 created by host operating system 122A in memory 105. In one embodiment, registry 134 is temporary, lasting only for as long as host operating system 122A is running.

Further, in some embodiments, identifiers for the bus are also included in registry 134. For example, the detected hardware devices may be organized hierarchically by the buses to which the hardware devices are connected. These buses include the buses typically supported by computing devices, such as, for example, the Peripheral Component Interface (PCI) bus, Universal Serial Bus (USB), IEEE 1394 bus, Industry Standard Architecture (ISA) bus, etc.

After host operating system 122A is loaded and the detection process is completed (i.e., registry 134 is created and populated with identifiers of the detected hardware devices), host operating system 122A causes operating system setup program 128 to be loaded into memory 105 of computing device 102, which is shown as operating system setup program 128A in FIG. 1. In other embodiments, the user can load the setup program. Operating system setup program 128A then runs to install an operating system (e.g., Windows XP® available from Microsoft Corporation) into computing device 102. In a conventional system, the operating system setup program would typically perform a detection process to detect hardware devices 106-1 through 106-M and 118-1 through 118-N. However, in accordance with this embodiment, operating system setup program 128A accesses registry 134 to find the identifiers of hardware devices 106-1 through 106-M and 118-1 through 118-N. That is, operating system setup program 128A uses the already present host operating system registry 134 to get identifiers of the attached hardware devices, which can then be used to determine which driver(s) of driver files 126 to install in computing device 102. This feature advantageously reduces the complexity of operating system setup program 128 and speeds up the driver installation process.

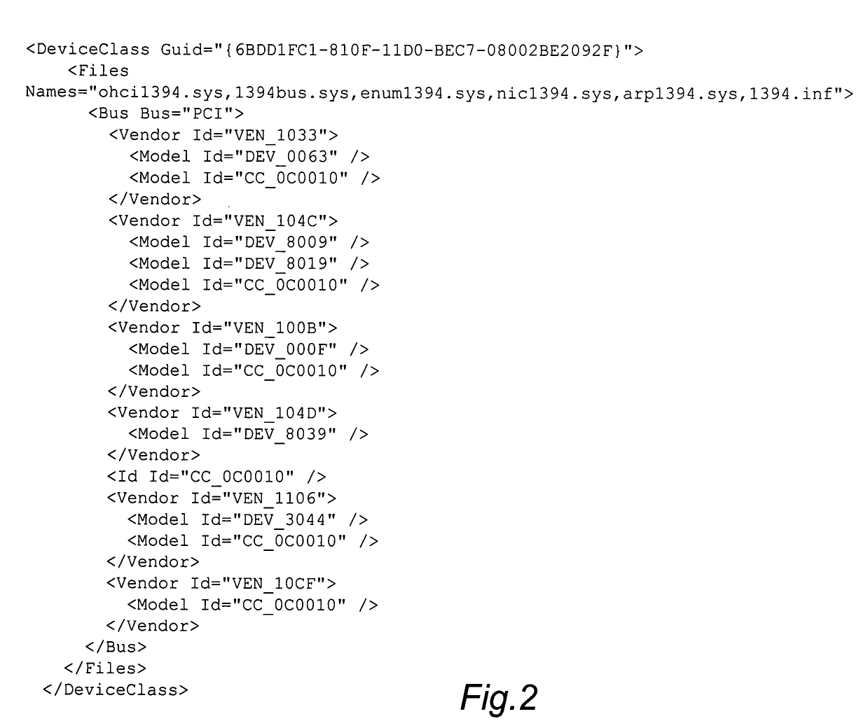

Operating system setup program 128A then searches mapping file 124 (which may be loaded into memory 105 in some embodiments) for identifiers of the drivers needed for each of the detected hardware devices. An example excerpt of mapping file 124 is illustrated in FIG. 2 for use in installing a Windows® operation system. In this example, mapping file 124 includes an eXtensible Markup Language (XML) file that lists names of driver files for a “class” of device, with further specification of the bus (e.g., PCI bus) and specific devices (by vendor identifier and model identifier) that are associated with the drivers of driver files 126. In one embodiment, mapping file 124 is obtained by parsing the .INF files that are associated with the drivers of driver files 126. An .INF file (as used in Windows® operating systems) is a text file that contains necessary information about device(s) and file(s) to be installed, such as driver images, registry information, version information, and so on, to be used by a Windows® setup program. As a result, mapping file 124 can be used to find appropriate drivers of driver files 126 for each hardware device listed in the mapping file. In other embodiments, mapping file 124 may be obtained in other ways.

Returning to FIG. 1, using the driver file identifiers (for the detected hardware devices) obtained from mapping file 124, operating system setup program 128A then installs the appropriate driver files (selected from driver files 126) into computing device 102. The installed drivers are illustrated in FIG. 1 as selected driver files 136 in storage device 108. Operating system setup program 128A then installs the rest of the operating system, as illustrated by operating system 138 in storage device 108.

Exemplary Remote Operating System/Driver Installation System

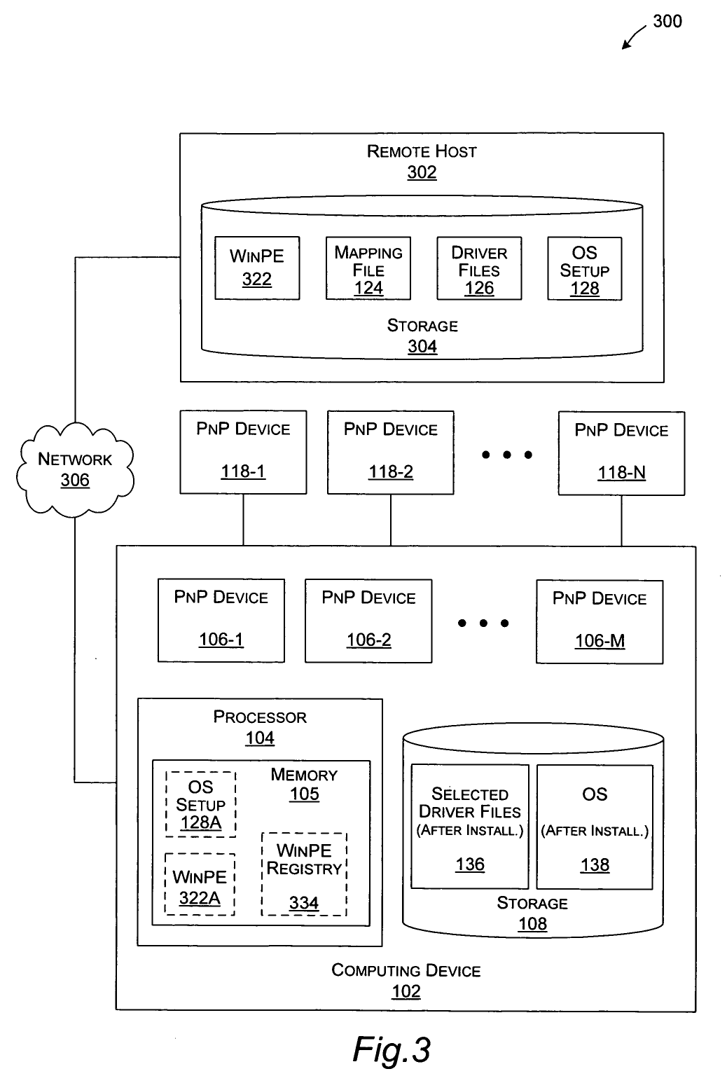

FIG. 3 illustrates an exemplary system 300 that uses device detection during remote host operating system installation for remote driver installation, according to an embodiment. This embodiment of system 300 is similar to system 100 (FIG. 1) except that boot device 116 with storage device 120 is replaced with remote host 302 (e.g., a server) having storage device 304, and a network 306 is used to connect remote host 302 to computing device 102 instead of the direct connection between boot device 116 and computing device 102 in system 100. Further, in this exemplary embodiment, a host operating system 322 stored in storage device 304 is implemented using WinPE®, which is loaded by computing device 102 from remote host 302 via network 306, and indicated as WinPE® host operating system 322A in main memory of processor 104. Storage device 304 also stores previously described mapping file 124, driver files 126 and operating system setup program 128.

In operation during a remote operating system installation scenario, computing device 102 boots from remote host 302 via network 306. For example, in computing device 102, the boot device can be set to the “network card” that supports communication over network 306. Computing device 102 may also include a “stub” (code that allows computing device to communicate with remote host 302 via network 306). During this boot process, computing device 102 loads host operating system 322 (i.e., WinPE®) from storage 304 into a main memory of processor 104. The loaded host operating system is shown in FIG. 3 as host operating system (WinPE®) 322A residing in memory 105 of processor 104.

In this embodiment, runs, one of the tasks host operating system 322A performs is detecting all of the hardware devices connected to computing device 102. In this example embodiment, host operating system 322A operates to detect PnP devices 106-1 through 106-M and PnP devices 118-1 through 118-N. Host operating system 322A stores identifiers for the detected devices in a data structure. In this embodiment, the identifiers are locally stored in a WinPE® registry 334 created by host operating system 322A in main memory. In one embodiment, WinPE® registry 334 is temporary, lasting only for as long as WinPE® is running on computing device 102.

After host operating system 322A is loaded and the detection process is completed (i.e., WinPE® registry 334 is created and populated with identifiers of the detected hardware devices), host operating system 322A causes operating system setup program 128 to be loaded into memory 105 of computing device 102, which is shown as operating system setup program 128A in FIG. 3. Operating system setup program 128A then runs to install an operating system (e.g., Windows XP® available from Microsoft Corporation) into computing device 102. Similar to operation of previously described system 100 (FIG. 1), operating system setup program 128A uses the already present WinPE® registry 134 to get identifiers of PnP devices 106-1 through 106-M and PnP devices 118-1 through 118-N, which can then be used to determine which driver(s) of driver files 126 to install in computing device 102. This feature advantageously reduces the complexity of operating system setup program 128 and speeds up the driver installation process.

Operating system setup program 128 then searches mapping file 124 for identifiers of the drivers needed for each of the detected hardware devices. Using the driver file identifiers (for the detected hardware devices) obtained from mapping file 124, operating system setup program 128 then installs the appropriate drivers (selected from driver files 126) into computing device 102. The installed drivers are illustrated in FIG. 3 as selected driver files 136 in storage device 108. Operating system setup program 128 then installs the rest of the operating system, as illustrated by operating system 138 in storage device 108.

Exemplary Source Operational Flow for Operating System/Driver Installation

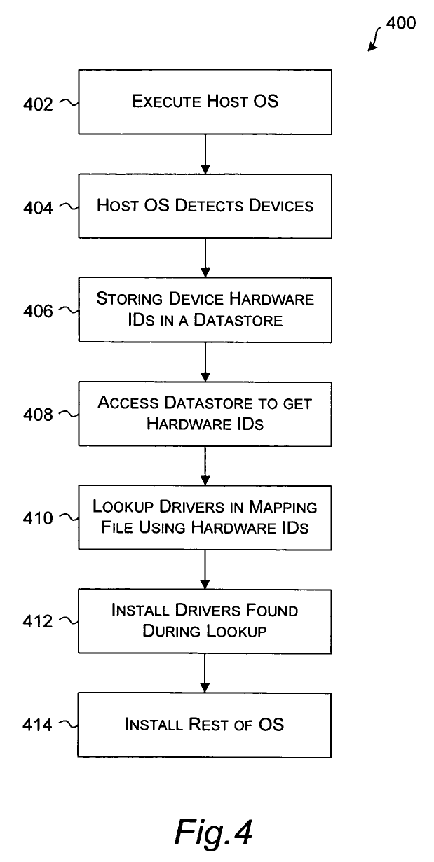

FIG. 4 is a flow diagram representing an operational flow 400 in installing an operating system and one or more device drivers into a computing device, according to an embodiment. Operational flow 400 may be performed in any suitable computing environment. For example, operational flow 400 may be executed by a system such as systems 100 or 300 (FIGS. 1 and 3, respectively). Therefore, the description of operational flow 400 may refer to at least one of the components of FIGS. 1 and 3. However, any such reference to components of FIGS. 1 and 3 is for descriptive purposes only, and it is to be understood that the implementations of FIGS. 1 and 3 are a non-limiting environment for operational flow 400.

At a block 402, a host operating system is executed on a computing device. In one embodiment, a host operating system such as WinPE® is loaded into the computing device during the boot process and then executed. In one embodiment, the host operating system is loaded from a boot device such as boot device 116 (FIG. 1) and then executed. In another embodiment, the host operating system is loaded from a remote host such as remote host 302 (FIG. 3).

At a block 404, the host operating system detects hardware devices (such as hardware devices 106-1 through 106-M and 118-1 through 118-N shown in FIGS. 1 and 3) that are connected to the computing device. In one embodiment, the host operating system and the hardware devices support the aforementioned PnP functionality, which allows the host operating system to detect the hardware devices and obtain their identifiers.

At a block 406, a datastore is populated with the identifiers obtained at block 404. In one embodiment, the host operating system creates a registry and adds the hardware identifiers to the registry. In one embodiment, the host operating system also includes information related to the bus used by the hardware device (e.g., PCI bus, USB, etc.) to communicate with the computing device.

At a block 408, the datastore is accessed to obtain the identifiers stored therein at block 406. In one embodiment, an operating system setup program running on the computing device accesses the datastore. For example, in one implementation the host operating system may load the operating system setup program (e.g., operating system setup program 128 shown in FIGS. 1 and 3) into the computing device, which when running accesses the datastore to determine which drivers need to be loaded.

At block 410, drivers (if any) needed for the hardware devices are determined. In one embodiment, the operating system setup file searches or looks up a mapping file such as mapping file 124 (FIGS. 1 and 3) to determine which drivers are needed by the computing device. In one embodiment, the mapping file contains a mapping of hardware device identifiers to identifiers of the drivers located in a set of driver files (such as driver files 126 shown in FIGS. 1 and 3), where each hardware device identifier listed in the mapping file is mapped to one or more drivers (of the set of driver files) that are used by the hardware device to properly operate. For example, using the identifiers stored in the datastore (block 408), the operating system setup program searches the mapping file for the hardware device identifiers, from which the operating system setup program obtains the identifiers of the hardware device's drivers.

At a block 412, the drivers obtained at block 410 are then installed in the computing device. In one embodiment, the operating system setup program installs the “selected” drivers (i.e., the drivers identified at block 410) in the computing device.

At a block 414, the rest of the operating system is installed in the computing device. In various embodiments, the operating system setup program installs the rest of the operating system in any suitable conventional manner.

Although operational flow 400 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

What is claimed is:

1. A method for installing driver files in a computing device having one or more hardware devices attached thereto, the method comprising:
executing a host operating system;
detecting, by the host operating system, the one or more hardware devices connected to the computing device;
storing, by a program in a datastore an identifier of a detected hardware device;
obtaining, by the program, an identifier of a driver that can be used by the detected hardware device; and
installing, by the program, the driver in the computing device.

2. The method of claim 1 wherein the host operating system comprises Windows® Pre-installation Environment.

3. The method of claim 1 wherein the datastore comprises a Windows® Pre-installation Environment registry.

4. The method of claim 1 wherein the identifier of the driver is obtained from a mapping file.

5. The method of claim 4 wherein the identifier of the driver is one of a plurality of identifiers of driver files to be installed for the detected hardware device.

6. The method of claim 1 wherein the hardware device comprises a plug and play device.

7. The method of claim 1 wherein the host operating system is installed in the computing device by a remote host.

8. One or more computer-readable media having stored thereon instructions that when executed by a computer implement the method of claim 1.

9. A system for installing driver files, the system comprising:
a device having a storage unit with a mapping file and a set of driver files;
a hardware device that uses a driver to operate; and
a computing device having a datastore and a storage device, the computing device being connected to the hardware device, wherein during execution of a host operating system by the computing device, the host operating system is to detect the hardware device and store an identifier of the hardware device in the datastore, and wherein during execution of a program by the computing device, the program is to:
access the datastore to obtain the identifier of the hardware device,
determine an identifier of the driver, and
install the driver into the computing device.

10. The system of claim 9 wherein the host operating system comprises Windows® Pre-installation Environment.

11. The system of claim 9 wherein the datastore comprises a Windows® Pre-installation Environment registry.

12. The system of claim 9 wherein the identifier of the driver is obtained from a mapping file.

13. The system of claim 12 wherein the identifier of the driver is one of a plurality of identifiers of driver files to be installed for the hardware device.

14. The system of claim 9 wherein the hardware device comprises a plug and play device.

15. The system of claim 9 wherein the host operating system is installed in the computing device by a remote host.

16. A computing device for installing driver files, the computing device comprising:
means for storing an identifier of a detected hardware device, wherein the hardware device was detected as being connected to the computing device by a host operating system;
means for accessing the means for storing to obtain the identifier of the hardware device;
means for obtaining an identifier of a driver that can be used by the detected hardware device using the identifier of the hardware device; and
means for installing the driver in the computing device.

17. The computing device of claim 16 wherein the host operating system comprises Windows® Pre-installation Environment and the means for storage comprises a Windows® Pre-installation Environment registry.

18. The computing device of claim 16 wherein the identifier of the driver is obtained from a mapping file.

19. The computing device of claim 16 wherein the hardware device comprises a plug and play device.

20. The computing device of claim 16 wherein the host operating system is installed in the computing device by a remote host.
